(19) United States
(12) Patent Application Publication
(10) Pub. No.: US 2023/0139788 A1
(43) Pub. Date: May 4, 2023

(54) HERBICIDE FORMULATIONS

(71) Applicant: Dow Global Technologies LLC, Midland, MI (US)

(72) Inventors: Hemasagar G, Mumbai (IN); Siddhartha Ghosal, Mumbai (IN)

(21) Appl. No.: 17/914,807

(22) PCT Filed: Jun. 29, 2021
(86) PCT No.: PCT/US2021/039550

§ 371 Date: Sep. 27, 2022

(30) Foreign Application Priority Data
Jul. 6, 2020 (IN) 202011028661

(51) Int. Cl. A01N 39/04; A01P 13/02

(52) U.S. Cl. CPC A01N 39/04; A01P 13/02

(57) ABSTRACT

A formulation includes a water-soluble salt of 2,4-dichlorophenoxyacetic acid; and 2.5 wt % to 10 wt % of a carrier fluid based on a total weight of the formulation. The carrier fluid includes 0.5 wt % to 5 wt % of solvent based on a total weight of the formulation, wherein the solvent is selected from the group consisting of ethylene glycol mono butyl ether, diethylene glycol monobutyl ether, dipropylene glycol monomethyl ether and combinations thereof; and 0.5 wt % to 5 wt % of a polyalkylene glycol monoalkyl ether surfactant based on a total weight of the formulation.

### BACKGROUND

### Field of the Invention

The present disclosure relates to herbicide formulations and specifically formulations comprising a water soluble salt of 2,4-Dichlorophenoxyacetic acid and a carrier fluid.

### Introduction

2,4-Dichlorophenoxyacetic acid (“DPA”) is an herbicide that is widely used to control the growth of broadleaf and woody plants. DPA selectively kills broadleaf weeds by causing uncontrolled growth within the plant, but leaves most grasses such as cereals, lawn turf, and grassland relatively unaffected. DPA is known as synthetic auxin because it kills the target weed by simulating the plant growth hormone auxin. The dosage of DPA on the plants plays a key role as the uncontrolled and disorganized growth that leads to plant death is a function of the dosage.

DPA has a low solubility in water and as such is traditionally formulated as a variety of different water-soluble salts (e.g. dimethylamine, diethanolamine, sodium, etc.) and esters (butyl, butoxyethyl, 2-ethylhexyl, isooctyl, etc.). Often, DPA is packaged and sold as a concentrate of water soluble salt and water. The concentrate is diluted with additional water within spraying equipment and the diluted concentrate is then applied to plants via spraying. Unfortunately, the DPA aqueous concentrate forms crystals due to the limited solubility of DPA with inorganic ions that are present in the water of the concentrate. The crystals do not dissolve upon dilution of the concentrate. The formation of the crystal is disadvantageous because the crystals block screens and nozzles of the spray equipment leading to deformed spray patterns causing poor herbicide application. Additionally, the formation of the crystals serves to decrease the overall concentration of herbicide in diluted concentrate.

The issue of crystal formation has been addressed in the art, but typically relies on the use of specialized crystallization inhibitors or large quantities of carrier material to support the DPA. For example, U.S. Pat. No. 8,486,862 addresses crystal formation of water-soluble salts of DPA in the presence of inorganic cations through the addition of specialized crystallization inhibitors such as polyethylenimine and polyvinylamine U.S. Pat. No. 2,558,762 addresses crystallization of a concentrate of DPA but relies on a minimum of 20 weight percent (“wt %”) carrier material utilizing high concentrations of oil and surface-active ingredients to maintain stability of the DPA and resist crystallization.

In view of the foregoing, it would be surprising to discover a formulation comprising a water-soluble salt of 2,4-dichlorophenoxyacetic acid and 2.5 wt % to 10 wt % of a carrier fluid comprised of a solvent and a surfactant that resists crystal formation for 30 days at 5° C.

### SUMMARY OF THE DISCLOSURE

The present disclosure provides a formulation comprising a water-soluble salt of 2,4-dichlorophenoxyacetic acid and 2.5 wt % to 10 wt % of a carrier fluid comprised of a solvent and a surfactant that resist crystal formation for 30 days at 5° C.

The inventors of the present application have discovered that formulations that comprise 2.5 wt % to 10 wt % of a carrier fluid comprising a polyalkylene glycol monobutyl ether surfactant and a solvent selected from the group consisting of ethylene glycol mono butyl ether, diethylene glycol monobutyl ether, dipropylene glycol monomethyl ether and combinations thereof can resist the formation of DPA crystals for 30 days at 5° C. The properties of the formulation are surprising because neither the solvent nor the surfactant alone are able to provide the crystallization benefits obtained by the formulation. Rather, the surfactant and solvent function synergistically to obtain the crystallization results of the formulation. Further surprisingly discovered was that not any mixture of the surfactant and solvent provide the synergistic effects, but rather a specific ratio of the solvent and surfactant provides the crystallization inhibition benefits obtained by the formulation.

The formulations of the present invention are particularly useful as agricultural mixtures.

According to a first feature of the present disclosure, a formulation, comprises: a water-soluble salt of 2,4-dichlorophenoxyacetic acid; and 2.5 wt % to 10 wt % of a carrier fluid based on a total weight of the formulation, wherein the carrier fluid comprises: 0.5 wt % to 5 wt % of solvent based on a total weight of the formulation, wherein the solvent is selected from the group consisting of ethylene glycol mono butyl ether, diethylene glycol monobutyl ether, dipropylene glycol monomethyl ether and combinations thereof; and 0.5 wt % to 5 wt % of a polyalkylene glycol monoalkyl ether surfactant based on a total weight of the formulation.

According to a second feature of the present disclosure, the formulation comprises from 1.5 wt % to 3.5 wt % of the surfactant based on a total weight of the formulation.

According to a third feature of the present disclosure, the solvent comprises diethylene glycol monobutyl ether, dipropylene glycol monomethyl ether.

According to a fourth feature of the present disclosure, the formulation comprises from 2.0 wt % to 5.0 wt % of the solvent based on a total weight of the formulation.

According to a fifth feature of the present disclosure, the solvent comprises polyethylene glycol mono butyl ether.

According to a sixth feature of the present disclosure, the formulation comprises from 1.0 wt % to 3.0 wt % of the solvent based on a total weight of the formulation.

According to a seventh feature of the present disclosure, the formulation is free of oil.

According to an eighth feature of the present disclosure, the surfactant has structure (I) defined below wherein m is from 20 to 40, n is from 0 to 10 and R is C₄H₉OH.

According to a ninth feature of the present disclosure, an agricultural mixture comprises 1 wt % to 95 wt % water based on the total weight of the agricultural mixture and the formulation of any of features 1-8.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise indicated.

As used herein, a “CAS number” is the chemical services registry number assigned by the Chemical Abstracts Service.

### Formulation

The present disclosure is directed to a formulation. The formulation comprises a water-soluble salt of 2,4-dichlorophenoxyacetic acid and a carrier fluid. The carrier fluid comprises a solvent and a surfactant. The formulation may be combined with water to form an agricultural mixture.

The formulation may be free of oil. As used herein, the term “free of” is defined to mean that the formulation comprises less than 0.5 wt % of an oil based on a total weight of the formulation. As used herein, the term “oil” is defined to mean a material that is derived from plant, animal, or mineral sources and is generally immiscible in water.

As will be explained in greater detail below, the formulation may resist forming crystals of DPA when stored at 5° C. for 10 days or greater, or 15 days or greater, or 20 days or greater, or 25 days or greater, or 30 days or greater. Such a feature may be advantageous in decreasing spray nozzle blockages and otherwise increasing the efficacy of the formulation with respect to herbicidal properties.

### Water-Soluble Salt

The formulation comprises a water-soluble salt of 2,4-dichlorophenoxyacetic acid. DPA is a member of the phenoxyacetic acid class of herbicides and exhibits a limited solubility in water in its acid form. Accordingly, DPA may be converted into a water-soluble salt in order to be formulated as an aqueous-soluble concentrate. Examples of water-soluble salts of DPA may comprise organo ammonium cations such as isopropyl ammonium, dimethyl ammonium, triethyl ammonium, monoethanol ammonium, diethanol ammonium, triethanol ammonium, triisopropanol ammonium and N,N,N-trimethylethanol ammonium (choline). In a specific example, the water-soluble salt of DPA is 2,4-D dimethylamine salt having a chemical formula of C₁₀H₁₃C₁₂NO₃ and a CAS number of 2008-39-1.

The formulation may comprise from 40 wt % to 99 wt % of the water-soluble salt of 2,4-dichlorophenoxyacetic acid based on a total weight of the formulation. For example, the formulation may comprise 40 wt % or greater, or 42 wt % or greater, or 44 wt % or greater, or 46 wt % or greater, or 48 wt % or greater, or 50 wt % or greater, or 52 wt % or greater, or 54 wt % or greater, or 56 wt % or greater, or 58 wt % or greater, or 60 wt % or greater, or 62 wt % or greater, or 64 wt % or greater, or 66 wt % or greater, or 68 wt % or greater, or 70 wt % or greater, or 72 wt % or greater, or 74 wt % or greater, or 76 wt % or greater, or 78 wt % or greater, or 80 wt % or greater, or 82 wt % or greater, or 84 wt % or greater, or 86 wt % or greater, or 88 wt % or greater, or 90 wt % or greater, or 92 wt % or greater, or 94 wt % or greater, or 96 wt % or greater, or 98 wt % or greater, while at the same time, 99 wt % or less, or 98 wt % or less, or 96 wt % or less, or 94 wt % or less, or 92 wt % or less, or 90 wt % or less, or 88 wt % or less, or 86 wt % or less, or 84 wt % or less, or 82 wt % or less, or 80 wt % or less, or 78 wt % or less, or 76 wt % or less, or 74 wt % or less, or 72 wt % or less, or 70 wt % or less, or 68 wt % or less, or 66 wt % or less, or 64 wt % or less, or 62 wt % or less, or 60 wt % or less, or 58 wt % or less, or 56 wt % or less, or 54 wt % or less, or 52 wt % or less, or 50 wt % or less, or 48 wt % or less, or 46 wt % or less, or 44 wt % or less, or 42 wt % or less of the water-soluble salt of 2,4-dichlorophenoxyacetic acid based on a total weight of the formulation.

The water-soluble salt of DPA may be added to the formulation as a blend of water and water-soluble salt of DPA. The wt % of water-soluble DPA salt present in the blend is expressed as a wt % solids of the liquid with wt % of solids being the wt % of the water-soluble salt of DPA based on a total weight of the combined water-soluble salt of DPA and water. The wt % solids of the mixture of water and water-soluble salt of DPA may be 40 wt % or greater, or 42 wt % or greater, or 44 wt % or greater, or 46 wt % or greater, or 48 wt % or greater, or 50 wt % or greater, or 52 wt % or greater, or 54 wt % or greater, or 56 wt % or greater, or 58 wt % or greater, or 60 wt % or greater, or 62 wt % or greater, or 64 wt % or greater, or 66 wt % or greater, or 68 wt % or greater, while at the same time, 70 wt % or less, or 68 wt % or less, or 66 wt % or less, or 64 wt % or less, or 62 wt % or less, or 60 wt % or less, or 58 wt % or less, or 56 wt % or less, or 54 wt % or less, or 52 wt % or less, or 50 wt % or less, or 48 wt % or less, or 46 wt % or less, or 44 wt % or less, or 42 wt % or less.

### Carrier Fluid

The formulation comprises the carrier fluid. The carrier fluid functions to suspend and prevent crystallization of the water-soluble salt of DPA. The carrier fluid comprises the solvent and the surfactant. The formulation comprises from 2.5 wt % to 10 wt % of the carrier fluid based on a total weight of the formulation. For example, the formulation may comprise 2.5 wt % or greater, or 3.0 wt % or greater, or 3.5 wt % or greater, or 4.0 wt % or greater, or 4.5 wt % or greater, or 5.0 wt % or greater, or 5.5 wt % or greater, or 6.0 wt % or greater, or 6.5 wt % or greater, or 7.0 wt % or greater, or 7.5 wt % or greater, or 8.0 wt % or greater, or 8.5 wt % or greater, or 9.0 wt % or greater, or 9.5 wt % or greater, while at the same time, 10.0 wt % or less, or 9.5 wt % or less, or 9.0 wt % or less, or 8.5 wt % or less, or 8.0 wt % or less, or 7.5 wt % or less, or 7.0 wt % or less, or 6.5 wt % or less, or 6.0 wt % or less, or 5.5 wt % or less, or 5.0 wt % or less, or 4.5 wt % or less, or 4.0 wt % or less, or 3.5 wt % or less, or 3.0 wt % or less of the carrier fluid based on a total weight of the formulation.

### Solvent

The carrier fluid comprises the solvent. Without being bound by theory, it is believed that the solvent, at least partially, functions as an inhibitor to the growth of crystals of the water-soluble salt of DPA. The solvent is selected from the group consisting of ethylene glycol monobutyl ether, diethylene glycol monobutyl ether, dipropylene glycol monomethyl ether and combinations thereof. In some examples the solvent comprises diethylene glycol monobutyl ether and/or dipropylene glycol monomethyl ether. In some examples, the solvent comprises ethylene glycol monobutyl ether.

The formulation comprises from 0.5 wt % to 5 wt % of solvent based on a total weight of the formulation. For example, the formulation comprises 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, while at the same time, 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less of the solvent based on a total weight of the formulation.

### Surfactant

The carrier fluid comprises the surfactant. The surfactant is a polyalkylene glycol monoalkyl ether surfactant. The polyalkylene glycol moiety of the surfactant may be comprised of polymerized derivatives of a C₁-C₆ oxide. A non-limiting example of the surfactant is provided by structure (I):

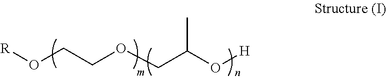

wherein R is a C₁-C₆ alkyl group, m is from 20 to 40, n is from 0 to 10 and has a weight average molecular weight of from 2000 g/mol to 4000 g/mol as measured using Gel Permeation Chromatography. In a specific example, m is 33, n is 6 and R is C₄H₉OH.

The formulation comprises from 0.5 wt % to 5 wt % of the surfactant based on a total weight of the formulation. For example, the formulation comprises 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, while at the same time, 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less of the surfactant based on a total weight of the formulation.

### Agricultural Mixture

The formulation may be utilized in an agricultural mixture. The agricultural mixture may be comprised of the formulation and from 1 wt % to 95 wt % water based on the total weight of the agricultural mixture. For example, the agricultural mixture may be 1 wt % or greater, or 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 75 wt % or greater, or 80 wt % or greater, or 85 wt % or greater, or 90 wt % or greater, while at the same time, 95 wt % or less, or 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less, or 15 wt % or less, or 10 wt % or less, or 15 wt % or less of water based on a total weight of the agricultural mixture.

The agricultural mixture may be formed in a variety of ways. For example, one or more components of the formulation may be mixed prior to the introduction of the water, or one or more components of the formulation may be directly mixed into the water to form the agricultural formulation.

### EXAMPLES

### Materials

The following materials were used in the preparation of the comparative examples (“CE”) and the inventive examples (“IE”).

DPA is a mixture of water and 2,4-D dimethylamine salt having a chemical formula of C₁₀H₁₃C₁₂NO₃ and a CAS number of 2008-39-1. The DPA is 58 wt % 2,4-D dimethylamine salt based on a total combined weight of the 2,4-D dimethylamine salt and the water. 2,4-D dimethylamine salt is commercially available from Sigma-Aldrich, St. Louis, Mo.

PPG is propylene glycol solvent having a weight average molecular weight of 2000 g/mol as measured according to gel permeation chromatography. Propylene glycol is commercially available from The Dow Chemical Company, Midland, Mich.

S1 is polyethylene glycol monobutyl ether surfactant having structure (I) where m is 33, n is 6, R is C₄H₉OH, the molecular weight is 2990 g/mol. 51 is available from The Dow Chemical Company, Midland, Mich.

GE is propylene glycol n-butyl ether; 3-butoxypropan-2-ol; propylene glycol monobutyl ether. GE is a solvent and has a molecular weight of 132.2. g/mol and is commercially available from The Dow Chemical Company, Midland, Mich.

DPME is dipropylene glycol monomethyl ether solvent and is commercially available from The Dow Chemical Company, Midland, Mich.

DEGM is diethylene glycol monobutyl ether solvent and is commercially available under the tradename BUTYL CARBITOL™ from The Dow Chemical Company, Midland, Mich.

AD is a solvent that is a 45 wt % mixture of alkyldiphenyloxide disulfonate in water and is commercially available under the tradename DOWFAX™ 2 A1 from The Dow Chemical Company, Midland, Mich.

S2 is a 50 wt % mixture of alkyl polyglucoside surfactant in water and is commercially available under the tradename TRITON™ CG-50 from The Dow Chemical Company, Midland, Mich.

EGME is ethylene glycol monobutyl ether solvent and is commercially available under the tradename Butyl CELLOSOLVE™ from The Dow Chemical Company, Midland, Mich.

### Sample Preparation

The inventive and comparative examples of the formulation were prepared by first mixing the surfactants (i.e., S1 or S2) of the example into the solvent (i.e., PPG, GE, DPME, DEGM, AD or EGME) of the sample to form the carrier fluid. Next the carrier fluid was added to the DPA. The samples were then mixed using a magnetic str bar for 10 minutes and deposited in glass bottles. The glass bottles of sample were stored at 5° C. in a refrigerator. Each day the samples were visually examined for the formation of crystals. Samples were removed from testing if the sample reached 30 days without crystal formation.

### Results

Table 1 provides the composition of comparative examples 1-20 and inventive examples 1-3 as well as the results of testing. Table 1 provides the wt % of the components of the sample based on a total weight of the sample.

TABLE 1

| | | | | | | | | | | Days without |
|---|---|---|---|---|---|---|---|---|---|---|
| | | | | | | | | | | crystal |
| Sample | DPA | PPG | S1 | GE | DPME | DEGM | AD | S2 | EGME | formation |
| CE1 | 100 | — | | | | — | — | — | | 1 |
| CE2 | 95 | 5 | | | | — | — | — | | 3 |
| CE3 | 90 | 10 | | | | — | — | — | | 5 |
| CE4 | 95 | — | | | | 5 | — | — | | 3 |
| CE5 | 95 | — | | | | 2.5 | 2.5 | — | | 1 |
| CE6 | 95 | — | | | | 3.35 | 1.65 | — | | 7 |
| CE7 | 95 | — | | | | 1.65 | 3.35 | — | | 1 |
| CE8 | 95 | — | | | | 3.35 | — | 1.65 | | 7 |
| CE9 | 95 | — | | | | 1.65 | — | 3.35 | | 1 |
| CE10 | 95 | — | | | | 2.5 | — | 2.5 | | 1 |
| CE11 | 90 | 10 | | | | | | | | 5 |
| CE12 | 95 | | 5 | | | | | | | 3 |
| CE13 | 95 | | | 5 | | | | | | 1 |
| CE14 | 95 | | | | 5 | | | | | 1 |
| CE15 | 95 | | | | | 5 | | | | 3 |
| CE16 | 95 | | | | | | | | 5 | 3 |
| CE17 | 95 | | 3.35 | 1.65 | | | | | | 10 |
| CE18 | 95 | | 1.65 | 3.35 | | | | | | 15 |
| CE19 | 95 | | 3.35 | | 1.65 | | | | | 10 |
| IE1 | 95 | | 1.65 | | 3.35 | | | | | 30 |
| CE20 | 95 | | 3.35 | | | 1.65 | | | | 10 |
| IE2 | 95 | | 1.65 | | | 3.35 | | | | 30 |
| IE3 | 95 | | 3.35 | | | | | | 1.65 | 30 |

CE1-CE19 use a variety of surfactant and solvent combinations to attempt to prevent crystal formation for long periods of time. Ultimately CE18 is able to resist crystal formation for 15 days. As shown in Table 1, IE1-IE3 all demonstrate no crystal formation for the duration of the testing. Further, IE1-IE3demonstrate synergistic and surprising results. For example, S1 alone (CE12) can only resist crystal growth for 3 days. Similarly, DPME (CE14), DEGM (CE15) and EGME (CE16) alone all only resist crystal growth for 3 days. However, the combinations of S1 and DPME (IE1), S1 and DEGM (IE2) and S1 and EGME (IE3) all exhibit extreme synergy in preventing crystal formation for a period of 30 days. Surprisingly discovered as well is that the combination of S1, DPME, DEGM and EGME at any concentration does not necessarily confer the same crystal formation inhibition. For example, CE19 and IE1 have opposite concentrations of S1 and DPME, yet IE1 exhibits a stability three times as great as CE 19. Similarly, the concentration S1 and DEGM of CE20 and IE2 are opposite, yet IE2 exhibits a stability three times as great as CE 20. Accordingly, the results of IE1-IE3 are surprising and advantageous.

1. A formulation, comprising:
a water-soluble salt of 2,4-dichlorophenoxyacetic acid; and
2.5 wt % to 10 wt % of a carrier fluid based on a total weight of the formulation, wherein the carrier fluid comprises:
0.5 wt % to 5 wt % of solvent based on a total weight of the formulation, wherein the solvent is selected from the group consisting of ethylene glycol mono butyl ether, diethylene glycol monobutyl ether, dipropylene glycol monomethyl ether and combinations thereof; and
0.5 wt % to 5 wt % of a polyalkylene glycol monoalkyl ether surfactant based on a total weight of the formulation.

2. The formulation of claim 1, wherein the formulation comprises from 1.5 wt % to 3.5 wt % of the surfactant based on a total weight of the formulation.

3. The formulation of claim 2, wherein the solvent comprises diethylene glycol monobutyl ether, dipropylene glycol monomethyl ether.

4. The formulation of claim 3, wherein the formulation comprises from 2.0 wt % to 5.0 wt % of the solvent based on a total weight of the formulation.

5. The formulation of claim 2, wherein the solvent comprises polyethylene glycol mono butyl ether.

6. The formulation of claim 5, wherein the formulation comprises from 1.0 wt % to 3.0 wt % of the solvent based on a total weight of the formulation.

7. The formulation of claim 1, wherein the formulation is free of oil.

8. The formulation of claim 1, wherein the surfactant has structure (I): 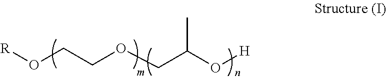
wherein m is from 20 to 40, n is from 0 to 10 and R is C₄H₉OH.

9. An agricultural mixture, comprising:
1 wt % to 95 wt % water based on the total weight of the agricultural mixture; and the formulation of claim 1.
